(19) United States
(12) Patent Application Publication
(10) Pub. No.: US 2014/0175243 A1
(43) Pub. Date: Jun. 26, 2014

(54) DISPLAY BOARD HANGER SYSTEM

(71) Applicant: W.A. KRAPF, INC., Macedon, NY (US)

(72) Inventors: Artem G. Sivak, Rochester, NY (US); John Deats, Brockport, NY (US); Christian Q. Krapf, Rochester, NY (US)

(73) Assignee: W.A. Krapf, Inc., Macedon, NY (US)

(21) Appl. No.: 13/722,718

(22) Filed: Dec. 20, 2012

(51) Int. Cl. F16M 13/02

(52) U.S. Cl. CPC F16M 13/02
USPC 248/316.1; 248/309.1; 29/428

(57) ABSTRACT

A board hanger system includes at least one hanger element defined by a body, including a center receiving hole, enabling the hanger element to be secured to a fixed supporting surface, said hanger element being rotatable about the center receiving hole and including an engagement portion on one side. The engagement portion is defined by a first dimension and a second shorter dimension. A display board includes a channel with a slot sized to receive the engagement portion of the hanger element and in which the hanger element is movable from a first position to a second position as rotated about the center receiving hole. Rotation from the first position to the second position causes the first dimension of the engagement portion to frictionally engage the channel and releasably clamps the hanger element relative to the display board.

### TECHNICAL FIELD

This application relates generally to the field of display board systems and more specifically to a hanger system for display boards.

### BACKGROUND

Presently there are known display board systems, which may include one or more display boards such as so-called “white” boards that can include at least one dry-erase surface, that are used frequently by different industries, hospitals, schools, governmental facilities, law firms, churches and the like for a myriad of purposes, such as tracking of events or schedules, patients and numerous other milestones. Some display systems incorporate a single display board, while other systems employ a plurality of display boards within a self supporting frame or alternatively as part of a kiosk. In some other versions, at least one display board can be hard mounted to an existing supporting surface such as a wall or office cubicle. In the latter versions, it can be difficult to effectively align and mount a single board or a plurality of adjacent display boards. These systems also often involve adhering or otherwise attaching a display board permanently to the supporting surface and do not provide ready means for removal and/or replacement or realignment of the board(s). Techniques have been provided, such as wall anchors, that provide adequate support of the boards, but do not permit flexibility in the hanging thereof.

### SUMMARY

In brief, the proposed concept relates to a system for hanging a display board to an existing supporting surface, such as a wall or office cubicle. The display board includes at least one channel sized to accommodate an engagement portion of a board hanger element. The board hanger element is defined by a body having a center receiving hole enabling the element to be initially secured to a wall or other supporting surface using a threaded fastener. Aligned with the center receiving hole is the engagement portion that can be fitted within one of the formed rear channels of the display board in a first position. The hanger element further includes a radially extending arm that can be gripped to permit the hanger element to be rotated about the center receiving hole. The engagement portion can be rotated into a fixed or locked position within the channel that retains the hanger using a frictional fit. By disposing board hanger elements at each corner or other suitable location(s), a display board can be suitably mounted by initially mounting each hanger element to the supporting surface, attaching a display board such that the engagement portions initially support the board, and then rotating the board hanger to the locked position in order to finally secure the board in place using a minimum of assembly steps. The display board can be selectively released by rotating the board hanger element in the opposite direction, which rotates the engagement portion to its initial position, enabling release of the display board but in which the hanger element remains secured to the supporting surface. Disposing a plurality of board hanger elements, for example, at corners or other suitable locations relative to the display board enables faster assembly time and aids in the assembly/aligmnent of a multiple display board system. Additional flexibility/versatility can be provided by providing the slotted portions along the length of the display board.

According to one version, there is provided a board hanger system comprising at least one hanger element having a body, including a center receiving hole enabling the at least one hanger element to be secured to an existing fixed supporting surface. The hanger element is rotatable about the center receiving hole and includes an engagement portion on one side. The engagement portion can be defined by upper and lower sides and lateral sides, the lateral sides being shorter in length than the upper and lower sides. A display board includes a rear facing side having at least one channel with a slot sized to receive the engagement portion of the hanger element and in which the hanger element is movable from a first position to a second position when rotated about the center receiving hole. Rotation from the first position to the second position releasably clamps the hanger element relative to the display board and therefore to the supporting surface as well.

According to another version, there is provided a method for releasably attaching a display board to a supporting surface, the method comprising the steps of providing at least one hanger element, securing the at least one hanger element to a supporting surface, placing an engagement portion of the hanger element into a channel defined by the display board and rotating the hanger element from the first position to a second position in order to clamp the display board to the supporting surface. Preferably, the hanger element(s) permit releasable retention of the display board.

The engagement portion is preferably defined by a shape that further enables securement through frictional engagement with the display board when the hanger element is rotated from the first position to the second position. In one version, the display board includes at least one channel dimensioned to receive the engagement portion and provide the frictional clamping engagement when the hanger element is rotated to the second position.

One advantage realized by the herein described hanger system and hanger elements is greater ease in hanging and alignment of display boards to a wall or other supporting surface.

Another advantage is that the attachment of the display board to the fixed supporting surface is releasable, thereby enabling replacement and realignment as needed.

Yet another advantage realized is that the channel dimensioned to receive the engagement portion of the display board hanger allows for ease of horizontal adjustment.

These and other technical features and advantages will be readily apparent from the following Detailed Description, which should be read in conjunction with the accompanying drawings.

### BRIEF DESCRIPTION OF THE DRAWINGS

FIG. 1 is a side perspective view of a display board hanger element used in accordance with an exemplary embodiment;

FIG. 2 is a front elevational view of the display board hanger element of FIG. 1;

FIG. 3 is a front perspective view of the display board hanger element of FIGS. 1 and 2;

FIG. 4 is a front elevational view of a display board hanger element made in accordance with another exemplary embodiment;

FIG. 5 is a side perspective view taken from the front side of an exemplary display board with a display board hanger element in a preassembled configuration;

FIG. 6 is an enlarged view of a portion of the display board and the display board hanger element of FIG. 5;

FIG. 7 is a side view, partially in section, of the display board of FIGS. 4 and 5, including a display board hanger element installed in an initial position;

FIG. 8 is a front facing view of the display board of FIG. 7, including the initially installed display board hanger element;

FIG. 9 is a side view, partially in section, of the display board of FIGS. 4-8, including the display board hanger element disposed in a clamped or retaining position;

FIG. 10 is a front facing view of the display board of FIGS. 4-9, including the display board hanger element as it would be seen in the clamped or engaged position; and

FIG. 11 is a rear facing view of the display board of FIGS. 4-10, with a plurality of display board hanger elements attached thereto.

### DETAILED DESCRIPTION OF EXEMPLARY MODES OF THE INVENTION

The following relates to certain exemplary embodiments for a display board hanger system, including a unique display board hanger element used in the system as well as a method of use and manufacture of same. Throughout the course of discussion that follows, certain terms are used throughout such as “top”, “bottom”, “upper”, “lower”, “side”, “front”, “rear” and the like. These terms provide a suitable frame of reference with regard to the accompanying drawings, but are not intended to overly limit of the inventive concepts that are described herein, including the claims, except where specifically and notably indicated.

In addition, the drawings presented herein are intended to adequately illustrate the salient features of the system, including the display board hanger element. To that end, it should be understood that the drawings may not he necessarily to scale and no reliance of any scaling of same should be made other than in providing the required understanding of features.

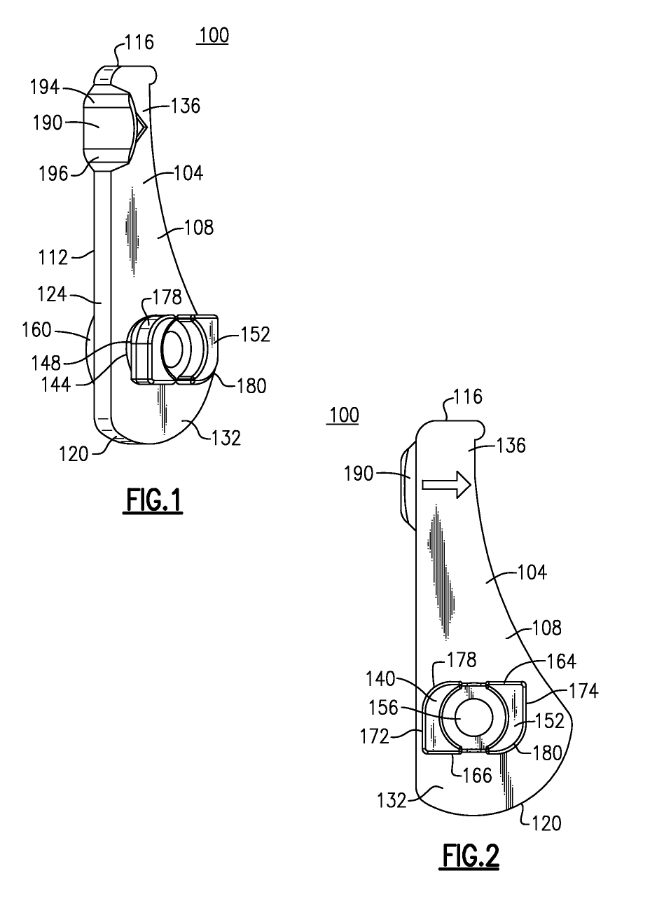

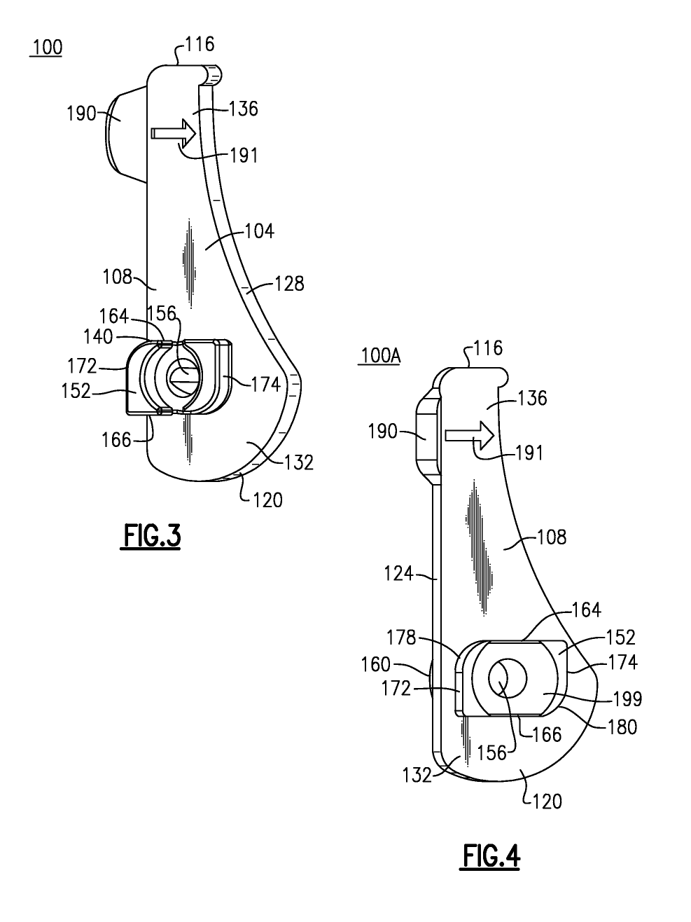

Turning to FIGS. 1-3, there is shown a display board hanger element 100 in accordance with a first exemplary embodiment. The hanger element 100 is defined by a body 104, preferably made from a single material such as a moldable durable plastic, although other suitable materials such as rubber, aluminum or steel could also be utilized. The body 104 is comprised of a substantially planar construction having opposing first and second face surfaces 108, 112 as well as respective side surfaces 116, 120, 124 and 128. The planar body 104 according to the present embodiment is defined by a substantially constant thickness, having a width dimension that varies from a maximum at a lower end 132 to a minimum width dimension at an opposing upper end 136. One of the side surfaces 124 extends along a major length dimension of the body 104 and is substantially flat, while the opposing side surface 128 is provided with a curved or scalloped configuration. Regarding the remaining side surfaces, one side surface 116 provided at the upper end 136 is substantially flat, while the opposing side surface 120 at the lower end 132 of the body 104 has a curved and substantially hemispherical shape.

Disposed on the first or inner face surface 108 and adjacent the lower end 132 of the body 104 is an engagement portion 140 extending outwardly from the plane defined by the first side surface 108. The engagement portion 140 includes a first extending section 144 having a substantially cylindrical surface 148, as well as a linearly adjacent second extending section 152. According to the present embodiment, the second extending section 152 is defined by a substantially rectangular configuration having a major dimension that extends along the width direction of the body 104 and a minor dimension extending along the length dimension of the body 104. The second extending section 152 extends outwardly from the first extending section 148 and is substantially larger in overall size, for reasons discussed herein.

A center receiving hole or opening 156 extends through the entirety of the body 104, including the engagement portion 140 as well as an opposing protrusion 160 that projects outwardly from the second or outer face surface 112. More specifically, the second extending section 152 is defined by an upper side edge 164, a lower side edge 166 and a pair of opposing lateral side edges 172, 174. The upper and lower side edges 164, 166 are parallel to one another and extend substantially perpendicular to the center receiving hole 156. The lateral side edges 172, 174 are also parallel to one another with the exception of a pair of curved surfaces 178, 180 formed at the top of the lateral side edge 172 and the bottom of the lateral side edge 174, respectively.

The second extending section 152 according to this embodiment includes a substantially cylindrical recess 184 extending beyond the diameter of the center receiving hole 156. The defined recess 184 forms a counter sink for the receiving hole 156 for purposes of receiving a threaded fastener and in which the radius of the recess 184 extends sufficiently such that portions of the upper and lower edges 164, 166 of the second extending section 152 are removed. A variation to the above design is illustrated by a display board hanger element 100A in FIG. 4. For purposes of this latter embodiment, similar parts are labeled with the same reference numerals for the sake of clarity wherein the display board hanger element 100A is defined by a planar body 104 having an engagement portion 140 including a second extending section 152 and a central receiving hole 152 adjacent the lower end 132. Also and as defined in the prior version, the second receiving section 152 is further defined by a substantially rectangular configuration having an upper edge 164, a lower edge 166, side edges 172, 176 and curved surfaces 178, 180 on opposing corners. According to this embodiment, the periphery of the central receiving hole 156 is provided with a tapered conical surface 199 to define a counter bore. Other variations can also be provided to enable various types of fasteners to be mounted thereon without interfering with the engagement of a display board.

Referring to FIGS. 1-4 and 11, the protrusion 160 formed on the opposing second face surface 112 of the body 104 and according to each exemplary embodiment is substantially circular.

Finally, the upper end 136 of the hanger element body 104 includes a tab member 190 disposed along the side surface 124 of the body 104 and extending outwardly relative to the plane of the front side surface 108, the tab member 190 including a pair of gripping surfaces 194, 196 on respective upper and lower sides thereof.

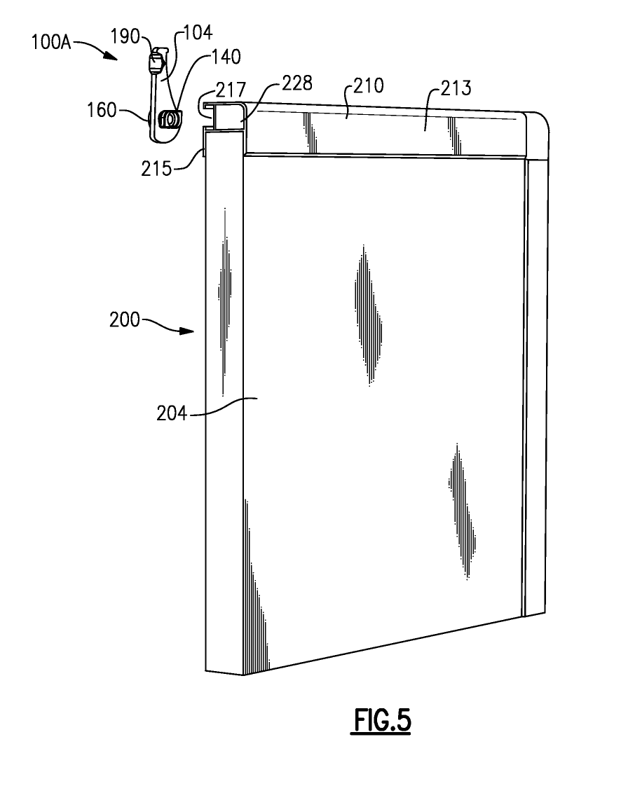

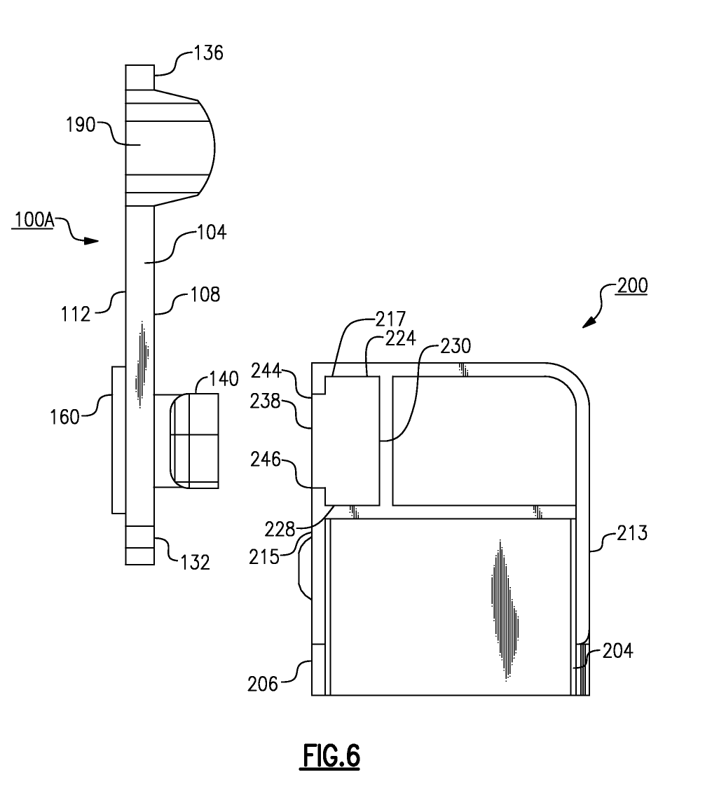

An exemplary display board for use with the herein described hanger element 100 is now described with reference to FIGS. 5 and 6. The display board 200 is defined by a front facing side 204 and an opposite rear facing side 206. The front facing side 204 can include a ceramic coating that is applied onto a steel sheet surface that enables use as a dry-erase surface in which the display board can be a so-called “white board” as described, by way of example, in U.S. Pat. No. 7,119,048, the entire contents of which are herein incorporated by reference. According to at least one version, a quantity of additional material, such as lightweight foam (not shown), can be provided within the center or core of the display board 200 between the front facing side 204 and rear facing side 206 in order to provide additional structural stability.

According to this version, an edge portion 210 is fitted over the top of the display board 200, the edge portion including planar front and rear surfaces 213, 215 as that are essentially planar with the front and rear facing surfaces 204 and 208, respectively, as well as a bottom wall 228. Additionally, similar edge portions 210, FIG. 11, can be disposed along the bottom and sides of the display board 200, as shown, in terms of an exemplary construction. Each edge portion 210 can include a rear channel 217. For purposes of the present embodiment and as illustrated in FIG. 6, only a single edge portion 210 is herein shown in detail relative to the top of a display board 200 to describe the engagement of a display board hanger element 100A with the display board 200.

Still referring to FIGS. 5 and 6, the rear channel 217 can extend over a portion or preferably over the entire length of the display board 200 and is defined by a substantially rectangular space having an upper wall 224, the lower or bottom wall 228, an intermediate back surface 230 and the rear facing surface 215 of the fitted edge portion 210. A longitudinal slot 238 is formed in the rear facing surface 215, creating respective upper and lower edges 244, 246. The rear channel 217 is sized to retain the engagement portion 140 of the display board hanger element 100A, the channel being defined by a height dimension that is larger than that of the longitudinal slot 238, as well as the length (major dimension) of the second extending section 152 of a display board hanger element 100A.

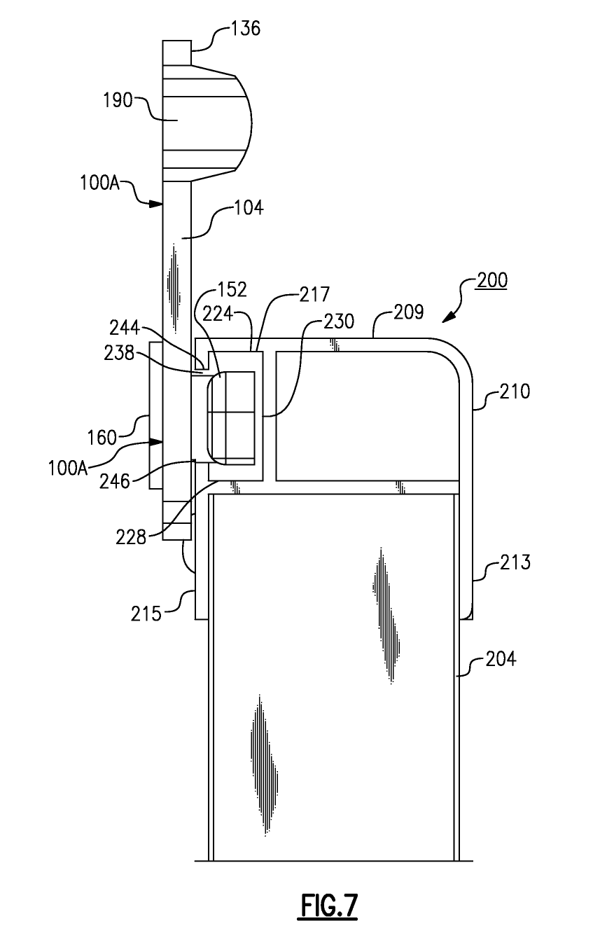

Referring to FIGS. 7-10, the assembly of a display board 200 using an exemplary display board hanger element 100A is herein described in greater detail. First, a display board hanger element 100A is mounted to an existing supporting surface (not shown) such as a wall or cubicle using a fastener such as a threaded fastener, screw, nail or other suitable member (not shown) that is attached through the center receiving hole 156 and in which the fastener is mounted through the counter sink; i.e., through the engagement portion 140 of the hanger element 100A. The above step fixedly mounts the hanger element 100A to the supporting surface, but the display board hanger element 100 is still freely rotatable about the center receiving hole 152. The protrusion 160 is placed into intimate contact with the supporting surface when the hanger element is secured thereto.

The display board 200 can then be attached to at least one display board hanger element 100A in which the engagement portion 140 is initially aligned with the rear channel 217 of the display board 200. To enable fitting within the channel 217, the major dimension (length) of the second extending portion 152 is aligned with the slot 238, permitting the display board 200 to be advanced toward the supporting surface wherein the second extending section 152 is fitted within the confines of the channel 217 and the first extending section 144 is fitted within the slot 238 and between the upper and lower edges 244, 246.

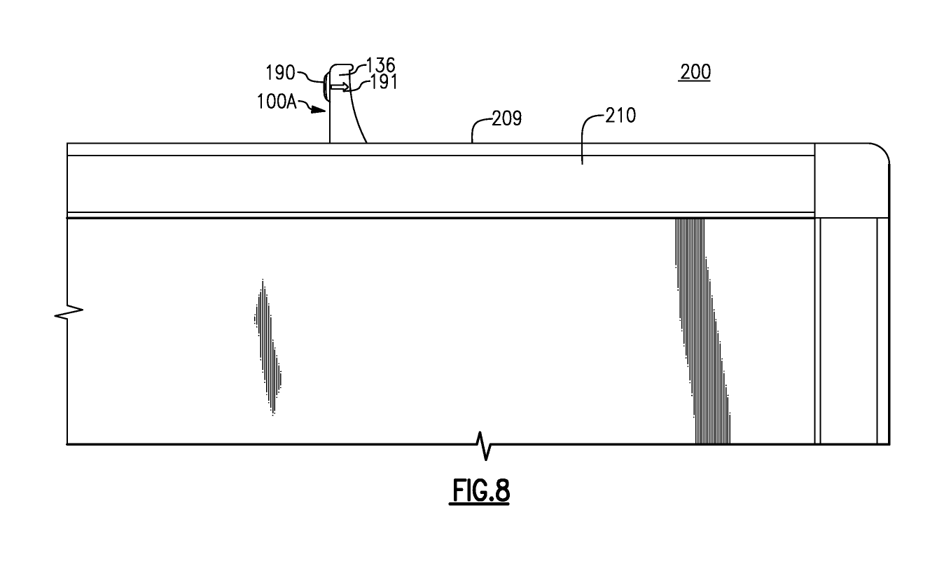

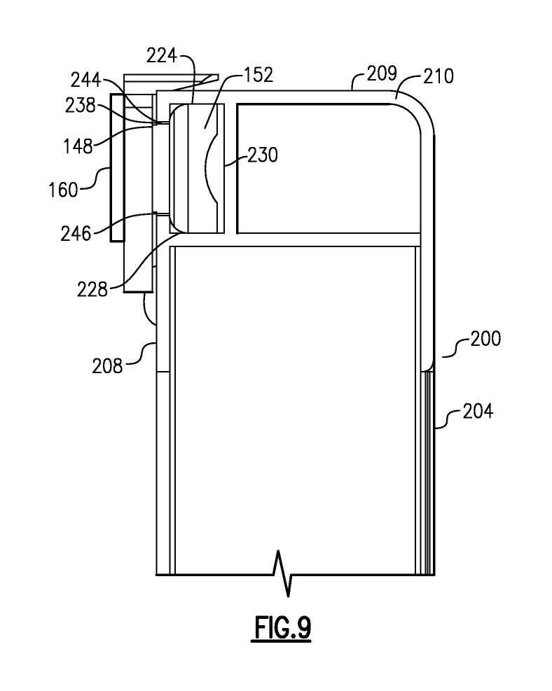

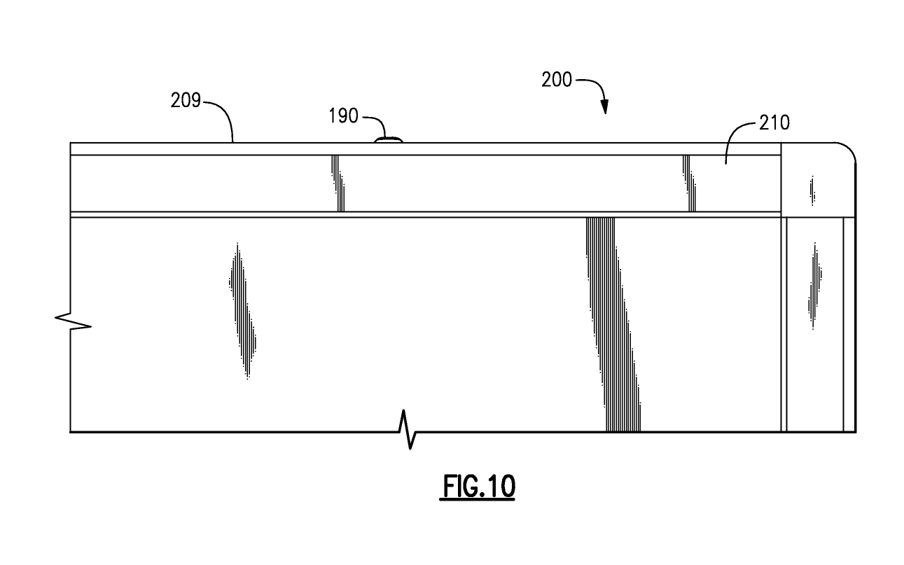

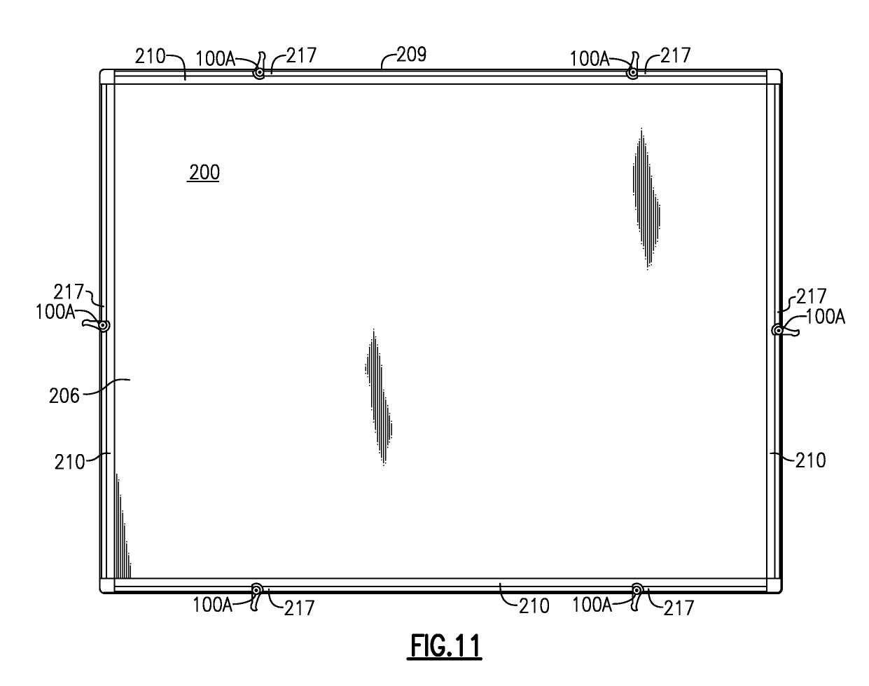

Referring to FIG. 8, the upper end 136 of the hanger body 104 extends outwardly as a radial arm projecting upwardly from the top edge 209 of the display board 200 wherein the tab member 190 can be easily gripped by the finger of a user (not shown) and rotated in the direction of arrow 191 (in this example, clockwise looking from the front of the display board). As shown in FIGS. 9 and 10, this rotation causes the second extending section 152 of the engagement portion 140 to rotate from the first position within the rear channel 217 to a second position, as facilitated by the curved surfaces 178 and 180. The rear channel 217 is sized to accommodate the rotation of the rectangular second extending section 152 wherein the first extending section 144 is initially seated within the defined slot 238 and sufficient radial clearance to effect this rotation and in which the curved surfaces 178, 180 of the second extending section 152 facilitate rotation to the second position.

Referring to FIGS. 9 and 10 and in the second position, the second extending section 152 is retained by frictional engagement between the upper and lower walls 224, 228 within the channel 217 that releasably secures or clamps the display board 200 in place. In the second position, the side surface 124 is substantially coplanar with the top edge 209 of the display board 200 with only a portion of the tab member 190 being seen and accessible above the surface of the top edge 209. To remove the display board 200 from the supporting surface, the extending arm of the hanger element 100A and more specifically the tab portion 190 is gripped by the user and the display board hanger element 100A is rotated in the opposite (counterclockwise) direction according to this example, which rotates the board engagement portion 140 to the original first position, FIGS. 7, 8, that permits release of the display board 200 from the hanger element 100A through the slot 238 of the rear channel 217.

A plurality of display board hanger elements 100A can be similarly attached and/or removed in the same manner and in which each hanger element 100A remains fixed to the supporting surface (not shown), thereby enabling display boards to be replaced, aligned or otherwise augmented, as needed.

### Parts List for FIGS. 1-11

100 display board hanger element
100A display board hanger element
104 body, hanger element
108 first or front face surface
112 second or rear face surface
116 side surface
120 side surface
124 side surface
128 side surface
132 lower end
136 upper end
140 engagement portion
144 first extending section
148 cylindrical surface
152 second extending section
156 center receiving hole or opening
160 opposing section/protrusion
164 upper side edge
168 lower side edge
172 lateral side edge
174 lateral side edge
178 curved surface
180 curved surface
184 recess
190 tab member
191 arrow
194 gripping surface
198 gripping surface
199 conical taper
200 display board
204 front facing side, display board
208 rear facing side, display board
209 top edge
210 cap section
213 front surface, edge section
215 rear surface, edge section
217 rear channels
220 interior cavity
224 upper wall
228 lower wall
230 back surface
244 upper edge
248 lower edge

It will be readily apparent that other modifications and variations can be made in accordance with the inventive concepts, which are described herein and in further are in accordance with the following claims.

1. A board hanger system comprising:
at least one hanger element comprising a body having a center receiving hole enabling said hanger element to be secured to a fixed supporting surface, said hanger element being rotatable about said center receiving hole and including an engagement portion, said engagement portion being defined by upper and lower edges and lateral sides, said lateral sides being shorter in length than said upper and lower sides; and
a display board having a channel sized to initially receive said engagement portion of said hanger element in a first orientation and in which said hanger element is movable within said channel from a first position to a second position when rotated about said center receiving hole such that rotation from said first position to said second position rotates said engagement portion into a second orientation that frictionally retains said hanger element within said channel.

2. A system as recited in claim 1, wherein said hanger element rotates approximately 90 degrees between said first position and said second position.

3. A system as recited in claim 1, wherein said hanger element is made from a durable molded plastic.

4. A system as recited in claim 1, wherein said hanger element includes an upper gripping end and a lower end supporting said engagement portion.

5. A system as recited in claim 4, wherein said engagement portion projects outwardly from said body and in which said body defines an extending radial arm.

6. A system as recited in claim 1, wherein said channel includes an interior cavity having first and second spaced surfaces in which ends of said engagement portion are sized to frictionally engage each of said first and second spaced surfaces when the hanger element is rotated to the second position.

7. A system as recited in claim 6, wherein said engagement portion is defined by a substantially rectangular configuration and in which two opposing corners of said engagement portion are curved to facilitate rotation in a preferred direction to create clamping.

8. A system as recited in claim 4, wherein said gripping end includes a tab portion.

9. A system as recited in claim 1, wherein said display board includes a plurality of channels sized for receiving a plurality of said hanger elements.

10. A system as recited in claim 1, wherein said engagement portion is defined by a substantially rectangular portion, said channel including an interior cavity having an upper surface and a lower surface in which lateral edges of the engagement portion engage the upper and lower surfaces when rotated to the second position.

11. A hanger element for use with display boards, said hanger element comprising:
a substantially planar body having an upper end and a lower end, said lower end including a center receiving hole enabling said hanger element to be secured to a fixed supporting surface and enabling said hanger element to be rotatable about said center receiving hole; and
an engagement portion projecting transversely from one side of said body at said lower end, said engagement portion being defined by a shape that is configured to be fitted into a channel of a display board, said engagement portion being configured to enable clamping within said channel when said body is rotated from a first position to a second position.

12. A hanger element as recited in claim 11, in which the center receiving hole is sized to receive a threaded fastener.

13. A hanger element as recited in claim 11, in which the center receiving hole is counter bored.

14. A hanger element as recited in claim 11, wherein said hanger element is made from a single material.

15. A hanger element as recited in claim 14, wherein said material is durable plastic.

16. A hanger element as recited in claim 11, wherein the upper end of said hanger element includes a tab portion.

17. A hanger element as recited in claim 11, wherein said engagement portion is defined by a substantially rectangular shape.

18. A hanger element as recited in claim 17, wherein the section of said engagement portion having said substantially rectangular shape is disposed adjacent a smaller first extending portion.

19. A hanger element as recited in claim 17, wherein a pair of opposing corners of said engagement portion are curved.

20. A method for releasably attaching a display board to a supporting surface, said method comprising the steps of:
securing a hanger element to a fixed supporting surface, said hanger element being rotatably secured to said supporting surface;
placing an engagement portion of the hanger element within a channel of the display board in a first position, said engagement portion having a first dimension and a second larger dimension; and
rotating the hanger element in a first predetermined direction causing the larger second dimension of the engagement portion to be placed into frictional clamping engagement with respective upper and lower surfaces of said channel.

21. A method as recited in claim 20, including the step of rotating said hanger element in an opposite direction to said first direction to release said engagement portion from said channel.
